(19) United States
(12) Patent Application Publication
(10) Pub. No.: US 2023/0019086 A1
(43) Pub. Date: Jan. 19, 2023

(54) PRODUCTION OF RENEWABLE CRUDE OIL

(71) Applicant: VALERO SERVICES, INC., San Antonio, TX (US)

(72) Inventor: William MALATAK, San Antonio, TX (US)

(73) Assignee: VALERO SERVICES, INC., San Antonio, TX (US)

(21) Appl. No.: 17/757,295

(22) PCT Filed: Dec. 14, 2020
(86) PCT No.: PCT/US2020/064919

§ 371 Date: Jun. 13, 2022

Related U.S. Application Data
(60) Provisional application No. 62/947,738, filed on Dec. 13, 2019.

(51) Int. Cl. C10G 3/00; C10G 7/00; C10G 61/02; C10G 67/02; C10L 1/08

(52) U.S. Cl. CPC C10G 3/50; C10G 7/00; C10G 61/02; C10G 67/02; C10L 1/08; C10G 2400/04; C10G 2400/08; C10G 2400/06; C10G 2300/1014; C10G 2300/1018; C10L 2200/0484; C10L 2290/24; C10G 2300/202; C10L 2270/04; C10L 2270/026

(57) ABSTRACT

The present disclosure relates to methods for the production of a renewable crude oil from plant oils and animal fats. The renewable crude is a drop-in renewable crude that can be processed in a petroleum refinery with minimal or no modifications.

### CROSS-REFERENCE TO RELATED APPLICATIONS

This application claims the benefit of U.S. Provisional Application No. 62/947,738 filed Dec. 13, 2019, all of which is hereby incorporated by reference in its entirety.

### FIELD OF THE INVENTION

This invention relates to the production of renewable crude oil from renewable plant and animal-based resources.

### BACKGROUND

The Renewable Fuel Standard (RFS) is an American federal program that requires transportation fuel sold in the United States to contain a minimum volume of renewable fuels. Renewable fuels may be generally defined as those derived from the processing and upgrading of various forms of biomass and degradable municipal waste feed stocks. Another definition used by regulatory and governing bodies around the world describes a renewable fuel as any fuel derived from renewable sources of biomass designed to reduce the amount of fossil fuel within the transportation fuel pool of a region.

The Environmental Protection Agency (EPA) has established a Renewable Identification Numbers (RINs) trading system as a mechanism for obligatory parties to demonstrate compliance with Renewable Volume Obligations (RVOs). RINs are tradeable electronic certificates assigned to each batch of biofuel for the purpose of tracking its production, use, and trading. Once a renewable fuel gets to an obligated party, RINs are then separated from the fuel and can be independently bought or sold in the form of electronically tradeable RFS credits to meet an obligated party's RVO.

The refining industry has largely focused on purchasing advanced biofuels from third parties to blend into their and other third party product pools to meet RFS and similar obligations. By using a renewable crude oil as an input source for a refinery front end, a refiner would acquire the flexibility to produce and sell a range of products with defined renewable content. Purchasing renewable crude oil would allow a refiner to avoid the risk and capital expenditure required at present to build their own renewable conversion units. The refiner could use tradeable RFS credits associated with renewable crude oil to comply with RVOs or exchange the tradeable credits through other corporate endeavors. Accordingly, there is a need in the transportation fuel refining industry for a renewable refinery drop-in crude or feed stock that can be processed with minimal to no refinery modifications.

### SUMMARY

The present disclosure provides at least one solution to sources for renewable crude oil. The solution is premised on methods for providing a petroleum refinery crude distillation unit with a feed stock that includes renewable crude oil. The methods disclosed herein provide means by which petroleum refiners can incorporate low-carbon-intensity crude feed stocks into a refining unit without the need for developing their own renewable crude input sources or renewable production facility.

Renewable fats and/or renewable oils are employed as low-carbon-intensity renewable feed stocks. The renewable feed stocks can be hydrogenated and hydrodeoxygenated in a hydrotreating unit to produce a renewable crude oil possessing electronically tradeable RFS credits. The renewable crude oil may be optionally isomerized, dewaxed, and/or at least partially hydrocracked to meet desired properties of higher value products. The renewable crude oil can then be blended with a petroleum-based crude oil prior to entry into the petroleum refinery crude distillation unit. Blending a petroleum-based crude oil with renewable crude oil allows a refiner to produce a product with a lower carbon intensity.

Some aspects of the present disclosure are directed to a process for producing a renewable crude oil from a renewable feed stock. In some embodiments, the process can include the steps of hydrotreating a renewable feed stock to produce a renewable crude oil and optionally isomerizing, dewaxing, and/or at least partially hydrocracking the renewable crude oil. In some aspects, the optional step of at least partially hydrocracking the renewable crude oil can include adjusting hydrocracking conditions to produce a hydrocracked renewable product having a defined composition ranges of constituent fractions including, but not limited to, naphtha, diesel, jet fuel, and gasoil. This can be done as a purely renewable feed stock or as mixture of a renewable feed stock and petroleum.

Some embodiments of the disclosure are directed to a process for reducing the carbon intensity of a petroleum refinery crude oil input. In some aspects, the process can include hydrotreating a renewable feed stock to produce a renewable crude oil and blending the renewable crude oil with a petroleum-based crude oil. Because the renewable crude oil is derived from a renewable source, the renewable crude oil has a carbon intensity value that is less than the carbon intensity value of the petroleum-based crude oil. Blending a high carbon intensity, petroleum-based crude oil with a relatively lower carbon intensity, renewable crude oil generates a blended crude oil whose aggregate carbon intensity value is less than that of a purely petroleum-based crude oil. The reduced carbon intensity, blended crude oil can be supplied as an input to the front end of a petroleum refinery. The refiner can generate electronically tradeable Renewable Fuel Standard credits, or similar equivalents in other countries, associated with the reduced carbon intensity, renewable crude oil.

### BRIEF DESCRIPTION OF THE DRAWINGS

FIG. 1 is a flow diagram depicting the steps involved in the production of renewable crude oil and renewable crude products.

### DETAILED DESCRIPTION

Various features and advantageous details are explained more fully with reference to the non-limiting embodiments that are illustrated in the accompanying drawing and detailed in the following description. It should be understood, however, that the detailed description and the specific examples, while indicating embodiments of the invention, are given by way of illustration only, and not by way of limitation. Various substitutions, modifications, additions, and/or rearrangements will become apparent to those of ordinary skill in the art from this disclosure.

In the following description, numerous specific details are provided to provide a thorough understanding of the disclosed embodiments. One of ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present disclosure provides a method for producing a renewable crude oil from a renewable feed stock that comprises a renewable feed stock component. Generally, renewable feed stock components are renewable fats and renewable oils that are predominantly non-petroleum fats and oils. In some aspects, renewable feed stock components include triglycerides, fats, fatty acids, fatty esters, and/or fat-derived materials. The renewable fats and renewable oils may originate from plant and animal sources. The renewable fats and renewable oils may include used cooking oil (UCO), recycled cooking oil, waste cooking oil, used vegetable oil, recycled vegetable oil, waste vegetable oil, rendered oils, animal fats, tallow, pork fat, chicken fat, fish oils, yellow grease, poultry fat, algal oils, algae-derived oils, soy oil, palm oil, palm fatty acids, plant-derived oils such as corn oil, rapeseed oil, canola oil, jatropha oil, olive oil, fatty acids, and seed oils, and the like. In one embodiment, the renewable feed stock includes at least 10% UCO. In some embodiments, the renewable feed stock includes at least 10% corn oil. In further embodiments, the renewable feed stock includes at least 10% UCO and at least 10% corn oil. The renewable fats and oils may be used alone, or may be used in combination with petroleum-based feed stocks. In some embodiments, the renewable feed stock components do not include biomass-based components. Biomass-based components include wood or forest residues, yard waste, food processing waste, e.g., corn cobs, manure, and human waste from sewage plants.

The margin for upgrading vegetable oils and animal fats to renewable crude oil can be economically advantageous. Margins per barrel can be lower than renewable diesel from UCO, due to the lower LCFS premium from vegetable oils. The lower margin can be offset by the higher production volumes. Higher margins can be achievable by supplementing the renewable feed stock with lower carbon intensity feed stocks such as corn oil and UCO.

The methods disclosed herein enable the production of a renewable crude oil feed stock that can be converted to products that are both fungible and indistinguishable from petroleum products. This has the potential to bridge a compatibility gap that currently exists between existing refining logistics systems and renewable products such as ethanol and biodiesel.

Another advantage to the current process is that refineries can lower their carbon footprint by using a renewable crude oil as a feed stock. There is also value in supplying renewable crude oil material to high carbon intensity crude producers looking to reduce the carbon intensity of the crude products. For example, a Canadian tar sands crude can be made to match the carbon intensity of West Texas Intermediate (WTI) crude by blending with renewable crude.

The renewable crude oil material disclosed herein can include primarily C4 to C24 paraffinic hydrocarbons with substantially no metals or carbon residue. A typical refining assay can include a mix of naphtha, kerosene, diesel, and gasoil fractions. A renewable crude oil production plant's hydrotreating conditions can be adjusted to meet customer needs by favoring the selective production of one fraction, or production of a mixture with a desired range of constituent fractions.

Some aspects of the disclosure are directed to a method for producing a renewable crude oil product. In some embodiments, the method can include the steps of hydrotreating a renewable feed stock to produce a renewable crude oil and optionally blending the renewable crude oil with a petroleum-based crude oil. The renewable feed stock may be optionally mixed with a petroleum-based oil or other renewable hydrocarbons prior to the hydrotreating step. In some aspects, the renewable crude oil or the blend of renewable crude oil and petroleum-based crude oil is distilled to produce a renewable crude product. In some aspects, the renewable feed stock can be pre-treated prior to the hydrotreating step. Pre-treating may include any one of, any combination of, or all of a degumming step, a chemical treating step, a water-wash step, a demetallation step, a bleaching step, an ion-exchange step, a full (or partial) hydrogenation step, an acid gas removal step, and/or a water removal step. In some aspects, degumming involves removal of contaminants such as gums, phosphorus-containing compounds, nitrogen-containing compounds, proteins, carbohydrates, chlorides, salts, metals, free fatty acids, chromophoric compounds, and other impurities from fats and oils. Exemplary degumming processes include but are not limited to water degumming, acid degumming, alkali degumming, chemical degumming, enzymatic degumming, extractive degumming, and/or thermal degumming. In some aspects, demetallation involves removal of metals such as sodium, potassium, calcium, and magnesium, and/or minerals. These contaminants may be detrimental or act as poisons to the hydrotreating and/or hydrodeoxygenation catalysts. In some aspects, the demetallation process produces a feed stock having a metal contaminant level of below 18 ppm. Degumming, water washing, and/or bleaching steps may also reduce metal content. A water wash step can include removal of residual water-soluble contaminants remaining in the renewable feed stock, such as acids, alkaline compounds, phosphorus-containing compounds, soaps, and salts. In some embodiments, a water was step can be used after a degumming step in order to remove residual contaminants. In some aspects, a bleaching process involves removal of phosphorus-containing compounds, gums, polymers, metals, salts, and compounds having higher molecular weights than that of the fat and oil base compounds of the renewable feed stock. In some aspects, bleaching involves mixing a granular or powdered bleaching earth material such as Fuller's earth with the renewable feed stock to form a slurry. In some aspects, the bleaching earth includes a montmorillonite clay comprises a general formula of Al₂Si₄O₁₀(OH)₂. In some aspects, the bleaching earth includes any one of, any combination of, or all of montmorillonite, kaolinite, and/or attapulgite. This slurry is maintained for a period of time to allow for the bleaching earth to absorb contaminants in the renewable feed stock, then fed to a filtration system to separate the bleaching earth material from the bleached oil. In some embodiments, a bleaching step is employed after a degumming step. Acid gas removal can include removal of gases such as

CO2 and H2S. Acid gas removal can include contacting the renewable feed stock with an alkaline solution that may include amines, aqueous sodium hydroxide solutions, and/or other alkaline liquids. In some embodiments, acid gases are removed from the hydrotreating reactor effluent by contacting the reactor effluent with an alkaline solution. Pre-treating may include one or more chemical treatment steps to remove contaminants. In some embodiments, a chemical treatment process utilizes an alkaline-treating step using compounds such as sodium or potassium hydroxide to remove metals, gums, and other contaminants. In some embodiments, a chemical treatment process involves an acid-treating that utilizes one or more acids such as acetic acid, citric acid, phosphoric acid or sulfuric acid, in order to remove metals, gums, and other contaminants. Each of the pre-treating and hydrotreating steps may involve the use of one or more catalysts. The renewable feed stock may be blended with a petroleum feed prior to or during the pre-treating step. In some embodiments, propane is produced during the hydrotreating step. This propane, also referred to as renewable propane, may be separated from the renewable crude oil after the hydrotreating step. In some embodiments, the renewable propane is used to produce hydrogen. In some embodiments, the renewable propane is used to produce propylene. In some aspects, the renewable propane is fed to a propane dehydrogenation unit to produce propylene and hydrogen. In some embodiments, the propylene is used to produce alkylate. In one embodiment a method for producing a renewable crude product comprises, consists essentially of, or consists of the steps of hydrotreating a renewable feed stock comprising a renewable feed stock component to produce a renewable crude oil, optionally blending the renewable crude oil with a petroleum-based crude oil, and distilling the renewable crude oil or the blend of renewable crude oil and petroleum-based crude oil to produce a renewable crude product.

Some aspects of the disclosure are directed to a renewable crude oil composition. In some embodiments, the renewable crude oil composition comprises at least 90 wt. %, 90 wt. % to 99.9 wt. %, 90 wt. % to 99 wt. %, 90 wt. % to 98 wt. %, 90 wt. % to 97 wt. %, 90 wt. % to 96 wt. %, 90 wt. % to 95 wt. %, 90 wt. % to 94 wt. %, 90 wt. % to 93 wt. %, 90 wt. % to 92 wt. %, or 90 wt. % to 91 wt. % C4 to C24 paraffins and less than 100 ppm, less than 90 ppm, less than 80 ppm, less than 70 ppm, less than 60 ppm, less than 50 ppm, less than 40 ppm, less than 30 ppm, less than 20 ppm, less than 10 ppm, or 0 ppm sulfur. In some aspects, the renewable crude oil composition can include at least 90, 91, 92, 93, 94, 95, 96, 97, 98, 99, or 100 wt. % or any range therein of C4 to C24 paraffins and less than 100 ppm sulfur. In some aspects, the renewable crude oil composition comprises from about 0.1-99.9% (or 1, 2, 3, 4, 5, 6, 7, 8, 9, 10, 15, 20, 25, 30, 35, 40, 45, 50, 55, 60, 65, 70, 75, 80, 85, 90, 95, or 99.9% or any range therein) by weight C4-C5 paraffins and from about 0.1-99.9% (or 1, 2, 3, 4, 5, 6, 7, 8, 9, 10, 15, 20, 25, 30, 35, 40, 45, 50, 55, 60, 65, 70, 75, 80, 85, 90, 95, or 99.9% or any range therein) by weight C6-C24 paraffins. In some embodiments, the renewable crude oil composition comprises from about 0.1-30% (or 1, 2, 3, 4, 5, 6, 7, 8, 9, 10, 15, 20, 25, or 30% or any range therein) by weight C4-C5 paraffins and from about 70-99.9% (or 71, 72, 73, 74, 75, 76, 77, 78, 79, 80, 81, 82, 83, 84, 85, 86, 87, 88, 89, 90, 91, 92, 93, 94, 95, 96, 97, 98, or 99% or any range therein) by weight C6-C24 paraffins. In some aspects, the renewable crude oil can include an aromatics content ranging from 0% to less than 25% (or 0, 1, 2, 3, 4, 5, 6, 7, 8, 9, 10, 11, 12, 13, 14, 15, 16, 17, 18, 19, 20, 21, 22, 23, 24, or 25 wt % or any range therein) by weight. In some embodiments, the renewable crude oil has a boiling range of about 7° C. (20° F.) to about 426° C. (800° F.) or about 7, 10, 20, 40, 60, 80, 100, 120, 140, 160, 180, 200, 220, 240, 260, 280, 300, 320, 340, 360, 380, 400, 420, or 426° C. or any range therein. In some aspects, the renewable crude oil can include any one of, any combination of, or all of C4, C5, C6, C7, C8, C9, C10, C11, C12, C13, C14, C15, C16, C17, C18, C19, C20, C21, C22, C23, and/or C24 paraffins. In some embodiments, the composition can include higher molecular weight paraffins such as C25, C26, C27, C28, C29, and/or C30 paraffins. In some embodiments, the renewable crude oil composition comprises less than 2%, less than 1%, less than 0.5%, less than 0.1%, or 0% by weight of methane. In some aspects, the renewable crude oil composition comprises less than 2%, less than 1%, less than 0.5%, less than 0.1%, or 0% by weight of C2. In some embodiments, the renewable crude oil comprises a Reid vapor pressure may range from about 0.01 psi to about 15 psi or 0.1, 1, 2, 3, 4, 5, 6, 7, 8, 9, 10, 11, 12, 13, 14, or 15 psi or any range therein. In embodiments, the renewable crude oil has a specific gravity of from about 0.62 to about 0.86. In some aspects, the renewable crude oil has a freeze point of greater than about −51° C. (−60° F.) and less than about 60° C. (140° F.) or −51° C., −45° C., −40° C., −35° C., −30° C., −25° C., −20° C., −15° C., −10° C., −5° C., 0° C., 5, ° C., 10° C., 15, ° C., 20° C., 25° C., 30° C., 35° C., 40° C., 45° C., 50° C., 55° C., or 66° C. or any range therein. In some embodiments, the renewable crude oil composition is produced by methods of the present inventions. For example, hydrotreating a renewable feed stock and optionally isomerizing, dewaxing, and/or at least partially hydrocracking the hydrotreated product can produce renewable crude oil compositions of the present invention. Isomerizing or isomerization can include the conversion of normal-paraffins into iso-paraffins. Dewaxing can include shortening or rearranging of hydrocarbons into compounds having shorter alkyl chains and/or compounds having lower melting points.

In some embodiments, a renewable crude oil composition can include iso-paraffins and normal- and iso-paraffins. In some embodiments, the renewable crude oil composition can include an iso-paraffin to normal-paraffin ratio of about 0.1 to about 12 or about 0.5, 1, 2, 3, 4, 5, 6, 7, 8, 9, 10, 11, or 12 or any range therein.

Some aspects of the disclosure are directed to a blended fuel composition comprising a blend of a renewable crude oil composition of the present inventions and a petroleum-based fuel and/or a different renewable-based fuel. Some embodiments of the disclosure are directed to a partially renewable crude comprising a blend of petroleum-based oil and at least 1 wt. % of a renewable crude oil produced from the hydroprocessing of a renewable feedstock. In some embodiments, the partially renewable crude has a sulfur content between 0.01 and 6.2 wt. %.

Some aspects of the disclosure are directed to a renewable crude oil blend comprising from 0.1 to 100% by weight of renewable crude oil and from 0-99.9% by weight of petroleum-based crude oil, wherein the renewable crude oil comprises less than 100 ppm sulfur and from about 0% to about 25% by weight of aromatics. The renewable crude oil may be blended with a petroleum-based crude oil in an amount greater than 0% to less than 99% by weight of renewable crude oil. These amounts may also range from greater than 0% to less than 80%, greater than 0% to less than 70%, greater than 0% to less than 60%, greater than 0% to less than 50%, greater than 0% to less than 40%, greater than 0% to less than 30%, greater than 0% to less than 20%, and greater than 0% to less than 10%, in each case by weight of renewable crude oil.

In some embodiments, hydrotreating the renewable feed stock involves contacting the renewable feed stock with a catalyst in the presence of hydrogen at elevated temperature and pressure to produce a renewable crude oil. In some embodiments, hydrotreating the renewable feed stock can include reacting the renewable feed stock with hydrogen at a reaction temperature ranging from about 149° C. to about 454° C. (300° F. to 850° F.), preferably at a temperature ranging from about 243° C. to about 416° C. (470° F. to 780° F.), or any range or value there between. The hydrotreating process may be performed at a pressure ranging from about 50 psig to about 3,400 psig, preferably at a pressure ranging from about 400 psig to about 1,800 psig, or any range or value there between. In some aspects, the hydrotreating process liquid hourly space velocity (LHSV) may range from about 0.1 to about 4.0 (hr⁻¹). Catalysts for the hydrotreating process include, but are not limited to, Ni—Mo and Co—Mo catalysts.

Hydrotreating is understood to broadly refer to processes that treat a feed stock with hydrogen, and reactions that occur during hydrotreating include hydrodeoxygenation, hydrodesulfurization, hydrodenitrification, decarboxylation, and saturation (hydrogenation) of olefins. The renewable feed stocks may include triglycerides and fatty acids (typically with chain lengths of C6-C24), anhydrides, esters, fatty alcohols, and combinations thereof. Esters may include mono-alcohol esters and polyol esters, such as triglycerides. The hydrotreating process may be a hydro-deoxygenation and hydrogenation process in which esters are cleaved, oxygenated compounds including acids and alcohols are reduced to the corresponding paraffins, and double bonds are saturated. Glycerin may be liberated during ester cleavage and hydrodeoxygenated to form renewable propane. In some embodiments, the renewable propane is separated from the renewable crude oil after the hydrotreating step. In some embodiments, the renewable propane is used to produce hydrogen. In some embodiments, the renewable propane is used to produce propylene. In some aspects, the renewable propane is fed to a propane dehydrogenation unit to produce propylene and hydrogen. In some embodiments, the propylene is used to produce alkylate. The renewable crude oil may include, in addition to propane, butane. More specifically, some butane, for example, n-butane, is produced during the hydrotreating process and may be separated from the renewable crude oil and fed to an isomerization unit where it is converted to renewable isobutane. In some embodiments, double bonds are reduced during hydrotreating. In some aspects, the hydrotreating process reduces the level of contaminants, including, but not limited to, Na, Ca, Mg, K, P, S, N, Cl, Si, Mg, Al, and oxygenated compounds. In some embodiments, the hydrotreating process reduces metal content of the renewable crude oil to less than 10 ppm. A preferred hydrotreating reaction system includes at least one reactor, each of which has at least one or more catalyst beds. In some embodiments, the hydrotreating process is performed in a hydrotreating reactor having at least three beds.

In some embodiments, the renewable crude oil is at least partially isomerized prior to blending the renewable crude oil with a petroleum-based crude oil. In some embodiments, the renewable crude oil is at least partially dewaxed prior to blending the renewable crude oil with a petroleum-based crude oil. In some embodiments, the renewable crude oil is at least partially hydrocracked prior to blending the renewable crude oil with a petroleum-based crude oil. In some aspects, the step of at least partially hydrocracking the renewable crude oil comprises producing a hydrocracked renewable product that includes at least one fraction selected from the group consisting of naphtha, diesel, jet fuel, and gasoil.

In some aspects, step of at least partially hydrocracking the renewable crude oil can include adjusting hydrocracking conditions, e.g., temperature, pressure, LHSV, and hydrogen feed rate, to produce a hydrocracked renewable product having a defined range of fractions. For example, hydrocracking conditions may be adjusted such that each of the naphtha, diesel, jet fuel, and gasoil fractions independently comprises from 0% to 100% of a hydrocracked product. The hydrotreating and optional isomerization, de-waxing, and/or hydrocracking may be performed in the same reactor or in different reactors. The optional isomerization, de-waxing, and/or hydrocracking of the renewable crude oil may be performed in the same reactor or in different reactors. Propane and/or butane may be produced during the steps of isomerization, de-waxing, and/or hydrocracking.

Some aspects of the disclosure are directed to a process for producing a renewable crude oil that includes the steps of hydrotreating a renewable feed stock comprising plant oils, animal fats or a blend thereof to produce a renewable crude oil comprising hydrotreated material, optionally isomerizing, dewaxing, and/or at least partially hydrocracking the hydrotreated material, and providing the renewable crude oil to a refinery processing unit. In some aspects, the renewable crude oil is processed under conditions suitable to produce naphtha, diesel, jet fuel, gasoil, or a combination thereof. In some embodiments, the renewable crude oil is mixed with petroleum-based crude oil and/or other renewable hydrocarbons prior to processing in a refinery processing unit. In some aspects, the renewable crude oil is mixed with petroleum-based crude oil and/or other renewable hydrocarbons to provide a blend that comprises from 0.1% to 99.9% of the renewable crude oil prior to processing in a refinery processing unit. In some aspects, the renewable crude oil is provided to a refinery processing unit (e.g., a refinery distillation unit) without having been with petroleum-based crude oil and/or other renewable hydrocarbons, i.e., a 100% renewable crude oil feed is provided to the refinery processing unit. In some embodiments, the optional steps of isomerizing, dewaxing, and/or at least partially hydrocracking the hydrotreated material are carried out in the same reaction zone. In some embodiments, the optional steps of isomerizing, dewaxing, and/or at least partially hydrocracking the hydrotreated material are carried out in different reaction zones. In some aspects, the renewable feed stock is pre-treated prior to the hydrotreating step. Pre-treating may include one or more of a degumming step, a chemical treating step, a water-wash step, a demetallation step, a bleaching step, an ion-exchange step, a full (or partial) hydrogenation step, an acid gas removal step, and a water removal step. In some embodiments, hydrotreating the renewable feed stock comprises reacting the renewable feed stock in a hydrotreating reactor with hydrogen at a reaction temperature ranging from about 149° C. to about 454° C. (300° F. to 850° F.), preferably at a temperature ranging from about 243° C. to about 416° C. (470° F. to 780° F.), or any range or value there between. The hydrotreating process may be performed at a pressure ranging from about 100 psig to about 3,400 psig, preferably at a pressure ranging from about 50 psig to about 1,800 psig. In some aspects, the hydrotreating process liquid hourly space velocity (LHSV) may range from about 0.1 to about 4.0 (hr⁻¹). In some embodiments, hydrotreating the renewable feed stock produces propane as a by-product. This renewable-sourced propane, or renewable propane can be separated from the renewable crude oil after the hydrotreating step. In some embodiments, the renewable propane is used to produce hydrogen. In some embodiments, the renewable propane is used to produce propylene. In some aspects, the renewable propane is fed to a propane dehydrogenation unit to produce propylene and hydrogen. In some embodiments, the propylene is used to produce alkylate.

In some aspects, the step of hydrotreating the renewable feed stock can include hydrodeoxygenating the renewable feed stock. In some embodiments, hydrodeoxygenation of renewable feed stock triglycerides produces renewable propane from the glycerin moiety, and the propane is removed from the renewable crude oil after the hydrotreating step. In some aspects, the optional step of at least partially hydrocracking the renewable crude oil comprises adjusting hydrocracking conditions to produce a hydrocracked renewable product having defined composition ranges of naphtha, diesel, jet fuel, and gasoil fractions.

Some aspects of the disclosure are directed to a process for reducing the carbon intensity of a petroleum refinery crude oil input, comprising hydrotreating a renewable feed stock to produce a renewable crude oil having a carbon intensity, and blending the renewable crude oil with a petroleum-based crude oil having a carbon intensity to produce a blended refinery input having a carbon intensity. Renewable feed stocks have lower carbon intensity values than petroleum-based crude oil. By blending the low carbon intensity renewable crude oil with the relatively higher carbon intensity petroleum-based crude oil, the resulting blended crude oil has a lower aggregate carbon intensity than the petroleum-based crude oil.

The renewable crude oils produced by the methods disclosed herein may have a lower cloud point and/or freezing point than conventional, petroleum-based crude oil. In some aspects, the freezing point of the renewable crude oil may range from −50° C. to 50° C., or any value or range there between. In some aspects, the density of the renewable crude oil may range from 0.62 to 0.92 grams per cubic centimeter or any value or range there between.

The renewable crude oil may comprise 50 ppm or less, preferably 10 ppm or less or any value or range there between, of Na, Ca, Mg, K, P, Mg, or other contaminants, providing no co-processing. In some embodiments, the renewable crude oil has an oxygen (O) content of less than 11%. In particular instances, the renewable crude oil has an oxygen (O) content of less than 1%. In some aspects, the renewable crude oil is substantially free of fatty acids and/or fatty esters. The renewable crude oil may contain propane, resulting from hydrogenation of glycerin. In some embodiments, at least a portion of any propane resulting from triglyceride hydrotreating (i.e., hydrogenation of glycerin to propane), is separated from the renewable crude oil. In some aspects, the renewable crude oil has a pour point in the range of about −18° C. to about 50° C. (−0.4° F. to 122° F.) or any value or range there between. In some embodiments, the renewable crude oil has a flash point ranging from −100° C. to 150° C. (−148° F. to 302° F.). In further embodiments, the renewable crude oil has a California Air Resource Board Certified LCFS carbon intensity value less than 55, as defined at: https://www.arb.ca.gov/fuels/lcfs/fuelpathways/pathwaytable.htm. In some embodiments, the renewable crude oil has a Reid vapor pressure (RVP) of less than 13 psi. RVP is a common measure of the volatility a hydrocarbon liquid and is defined as the absolute vapor pressure exerted by the vapor of the liquid and any dissolved gases/moisture at 37.8° C. (100° F.) as determined by the test method ASTM-D-323.

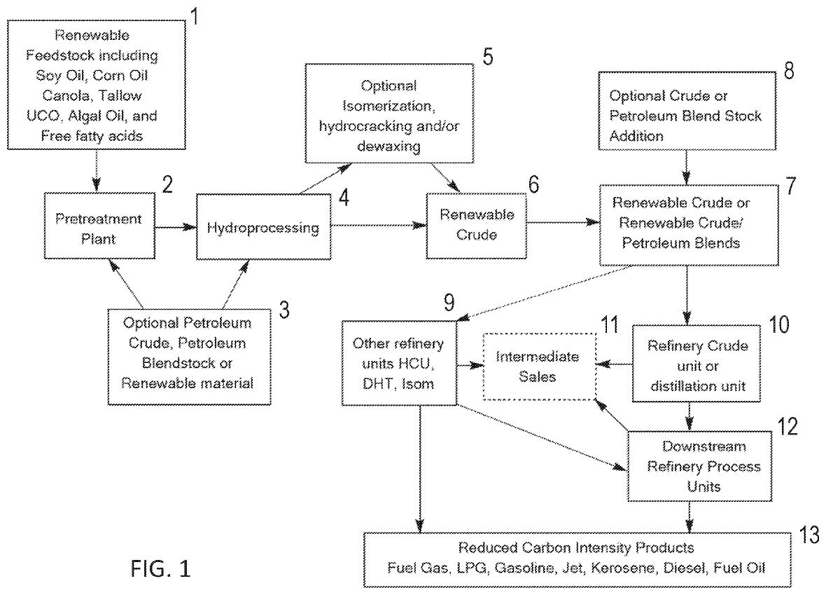

Referring now to FIG. 1, a flow diagram is depicted with an embodiment of the steps involved in the production of renewable crude oil and renewable crude products. In this embodiment, a renewable animal or plant-based feed stock (1) enters the optional pretreatment plant (2) and undergoes a pretreatment. The exemplary renewable feed stocks depicted can include palm oil, soy oil, corn oil, canola oil, tallow, UCO, algal oil, and other triglycerides and free fatty acids. Petroleum crude, a petroleum blendstock, or a renewable material (3) can be blended with the renewable feed stock prior to hydroproces sing and prior to the optional pretreatment step. The pretreated feed stock enters a hydroproces sing (hydrotreating) unit (4) and undergoes hydroprocessing, i.e., cleavage of triglycerides and decarboxylation of fatty acids to produce the renewable crude oil (6). The hydrotreating unit may use hydrogen generated in a hydrogen plant. Hydrotreating of triglyceride-containing renewable feed stocks can produce renewable propane, which may be removed from the renewable crude oil in a fractionation unit or separation unit. The hydrotreated product may be optionally isomerized, hydrocracked, and/or dewaxed in a corresponding isomerization, hydrocracking, and/or dewaxing unit (5). A crude blend stock or petroleum blend stock (8) may be added to the hydrotreated material prior to any of the optional isomerization, hydrocracking, and dewaxing steps. The hydrotreated (and optionally isomerized, hydrocracked, and/or dewaxed) product is a renewable crude oil. The renewable crude oil may be optionally blended with crude blend stock or petroleum blend stock (8) to produce a renewable crude/petroleum blend (7). Note that blending with crude blend stock or petroleum blend stock (8) is optional, and renewable crude/petroleum blend (7) may also represent a non-blended renewable crude. Renewable crude or renewable crude/petroleum blend (7) can then be sent to a refinery crude unit or distillation unit (10) for fractionation followed by further processing in downstream refinery process units (12) to produce reduced carbon intensity products (13). Renewable crude or renewable crude/petroleum blend (7) can optionally be sent to other downstream conversion units and/or other non-fractionating refinery units (9), including but not limited to a hydrocracking unit (HCU), a fluid catalytic craking unit (FCC), a diesel hydrotreating unit (DHT), an isomerization unit, or another refinery unit, and effluents collected as reduced carbon intensity products (13). Effluents of refinery crude unit or distillation unit (10), downstream refinery process units (12), and or other non-fractionating refinery units (9) may be sold or traded through intermediate sales (11).

A “glyceride” is an ester of glycerol and at least one carboxylic acid. Glycerides include mono-, di-, and triglycerides. A “fatty acid” is defined as a carboxylic acid consisting of a hydrocarbon chain and a terminal carboxyl group. A “fatty ester” is defined as an ester of a carboxylic acid. As used herein, the term “paraffins” refers to normal paraffins, iso-parrafins, or a combination of normal paraffins and iso-paraffins. The phrase “cloud point” refers to the temperature below which wax in a mixture of hydrocarbons forms a cloudy appearance. An “alkylate” is defined as the product of an alkylation reaction between an olefin and isobutane. The terms “a” and “an” are defined as one or more unless this disclosure explicitly requires otherwise. The term “substantially” is defined as being largely but not necessarily wholly what is specified (and include wholly what is specified) as understood by one of ordinary skill in the art. In any disclosed embodiment, the term “substantially” may be substituted with “within” [a percentage] of what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a blend or renewable crude oil composition that “comprises,” “has,” “includes” or “contains” one or more elements possesses those one or more elements, but is not limited to possessing only those one or more elements Likewise, an element of a system or composition that “comprises,” “has,” “includes” or “contains” one or more features possesses those one or more features, but is not limited to possessing only those one or more features.

The methods of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the methods of the present invention are their abilities to produce renewable crude oil, which can be further processed or blended to meet produce higher value products.

The feature or features of one embodiment may be applied to other embodiments, even though not described or illustrated, unless expressly prohibited by this disclosure or the nature of the embodiments. Any embodiment of any of the disclosed composition, system, or process can consist of or consist essentially of, rather than comprise/include/contain/have, any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb. Details associated with the embodiments described above and others are presented below.

Implementation of the renewable crude oil production methods disclosed herein allow for the conversion of renewable feedstocks into renewable low carbon intensity crude oil. The renewable crude oil can be used by new or existing refiners to selectively adjust and optimize the renewable content of their gasoline, jet and diesel products. Production of a low carbon intensity crude oil allows refiners to incorporate low carbon crude feedstocks without the large capital investments required to develop their own renewable plants.

The claims are not to be interpreted as including means-plus- or step-plus-function limitations, unless such a limitation is explicitly recited in a given claim using the phrase(s) “means for” or “step for,” respectively.

1. A method of producing a renewable crude product, the method comprising the steps of:
hydrotreating a renewable feed stock comprising a renewable feed stock component to produce a renewable crude oil;
optionally blending the renewable crude oil with a petroleum-based crude oil; and
distilling the renewable crude oil or the blend of renewable crude oil and petroleum-based crude oil to produce a renewable crude product.

2. The method of claim 1, further comprising a pre-treating step comprising pre-treating said renewable feed stock prior to said hydrotreating step.

3. The method of claim 2, wherein said pre-treating step comprises at least one of a degumming step, a chemical treating step, a water-wash step, a demetallation step, a bleaching step, an ion-exchange step, a full (or partial) hydrogenation step, an acid gas removal step, and a water removal step.

4. The method of claim 1, wherein said step of hydrotreating comprises a reaction temperature ranging from 149° C. to 454° C.

5. The method of claim 1, wherein said step of hydrotreating the renewable feed stock comprises hydrodeoxygenating the renewable feed stock.

6. The method of claim 1, further comprising separating renewable propane from the renewable crude oil after said hydrotreating step and prior to said distillation step.

7. The method of claim 6, wherein said renewable propane is used to produce hydrogen.

8. The method of claim 6, wherein said renewable propane is used to produce propylene.

9. The method of claim 8, wherein the propylene is used to produce alkylate.

10. The method of claim 1, further comprising at least partially isomerizing the renewable crude oil prior to said optional blending step or distillation step.

11. The method of claim 1, further comprising at least partially dewaxing the renewable crude oil prior to said optional blending step or distillation step.

12. The method of claim 1, further comprising at least partially hydrocracking the renewable crude oil prior to said optional blending step or distillation step.

13. The method of claim 12, wherein said step of at least partially hydrocracking the renewable crude oil comprises producing a hydrocracked renewable product comprising at least one fraction selected from the group consisting of naphtha, diesel, jet fuel, and gasoil.

14. The method of claim 12, wherein said step of at least partially hydrocracking the renewable crude oil comprises adjusting hydrocracking conditions to produce a hydrocracked renewable product having defined composition ranges of constituent fractions.

15. The method of claim 1, wherein the blending step comprises blending said renewable crude oil and said petroleum-based crude oil in a range selected from greater than 0% and less than 99%, greater than 0% and less than 80%, greater than 0% and less than 70%, greater than 0% and less than 60%, greater than 0% and less than 50%, greater than 0% and less than 40%, greater than 0% and less than 30%, greater than 0% and less than 20%, or greater than 0% and less than 10% by weight of said renewable crude oil.

16. A process for producing a renewable crude oil, said process comprising:
hydrotreating a renewable feed stock, the renewable feedstock comprising plant oils, animal fats or a blend thereof to produce a renewable crude oil comprising hydrotreated material;
optionally dewaxing, isomerizing, and/or hydrocracking the hydrotreated material; and
providing the renewable crude oil to a refinery processing unit.

17. The process of claim 16, further comprising the step of pre-treating said renewable feed stock prior to said hydrotreating step. wherein said pre-treating step comprises at least one of a degumming step, a chemical treating step, a water-wash step, a demetallation step, a bleaching step, an ion-exchange step, a full (or partial) hydrogenation step, an acid gas removal step, and a water removal step.

18. The process of claim 16, wherein said step of hydrotreating the renewable feed stock comprises reacting the renewable feed stock with hydrogen at a reaction temperature ranging from 149° C. to 454° C.

19. The process of claim 16, wherein said step of hydrotreating the renewable feed stock comprises hydrodeoxygenating at least a portion of the renewable feed stock.

20. The process of claim 16, further comprising the step of separating renewable propane from the renewable crude oil after said hydrotreating step.

21. The process of claim 20, wherein said renewable propane is used to produce hydrogen.

22. The process of claim 20, wherein said renewable propane is used to produce propylene.

23. The process of claim 22, wherein the propylene is used to produce alkylate.

24. The process of claim 16, wherein the renewable crude oil is processed under conditions suitable to produce naphtha, diesel, jet fuel, gasoil, or a combination thereof.

25. The process of claim 16, wherein the plant oil comprises soy oil, rapeseed oil, canola oil, algal oil, or a blend thereof.

26. The process of claim 16, wherein the animal fat comprises cooking oil, yellow grease, tallow oil or a blend thereof.

27. A process for reducing the carbon intensity of a petroleum refinery crude oil input, the process comprising:
hydrotreating a renewable feed stock to produce a renewable crude oil having a carbon intensity; and
blending the renewable crude oil with a petroleum-based crude oil having a carbon intensity to produce a blended refinery input having a carbon intensity,
wherein the blended refinery input carbon intensity is lower than the petroleum-based crude oil carbon intensity.

28. A renewable crude oil composition, said renewable crude oil comprising at least 90 wt. % C4 to C24 paraffins, and less than 100 ppm sulfur.

29. The renewable crude oil composition of claim 28, wherein said composition comprises:
from about 0.1 to 30 wt. % C4-C5 paraffins; and
from about 70 wt. % to 99.9 wt. % C6-C24 paraffins.

30. The renewable crude oil composition of claim 28, wherein said composition comprises an aromatics content ranging from 0% to up to 25% by weight.

31. The renewable crude oil composition of claim 28, wherein said composition comprises a Reid vapor pressure of less than 0.01 psi to 15 psi.

32. The renewable crude oil composition of claim 28, wherein said composition comprises a specific gravity of from about 0.62 to about 0.86.

33. The renewable crude oil composition of claim 28, wherein said composition comprises a freeze point of greater than about −51° C. and less than about 32° C.

34. The renewable crude oil composition of claim 28, wherein said composition comprises an iso-paraffin to normal-paraffin ratio ranging from about 0.1 to about 12.

35. A fuel blend comprising the composition of any one of claims 28 to 34.

36. The fuel blend of claim 35, further comprising a petroleum-based fuel and/or a different renewable-based fuel.

37. A renewable crude oil blend, said renewable crude oil blend comprising:
0.1 to 100% by weight renewable crude oil; and
0-99.9% by weight petroleum-based crude oil;
wherein the renewable crude oil comprises less than 100 ppm sulfur and from about 0% to about 25% by weight of aromatics.
